(19) United States
(12) Patent Application Publication
(10) Pub. No.: US 2011/0249685 A1
(43) Pub. Date: Oct. 13, 2011

(54) Method and device for scheduling data communication input ports

(75) Inventors: Xiushuai Liang, Shenzhen (CN); Zhuxing Lu, Shenzhen (CN)

(73) Assignee: ZTE CORPORATION, Shenzhen, Guangdong (CN)

(21) Appl. No.: 13/140,489

(22) PCT Filed: Dec. 25, 2009
(86) PCT No.: PCT/CN2009/076077

§ 371 Date: Jun. 17, 2011

(30) Foreign Application Priority Data
Apr. 30, 2009 (CN) 200910107184.0

(51) Int. Cl. H04L 12/403

(52) U.S. Cl. 370/449

(57) ABSTRACT

The present invention provides a method and device for scheduling data communication input ports, which comprises: monitoring a state of input ports, acquiring the information about valid input ports, dynamically allocating the buffer size for the valid input ports according to the valid input ports, calculating a time slice according to the bandwidth and priority of each valid input ports, and serving each valid input port according to the priority of the valid input ports and different time slices. With the solution of the present invention, the problems of buffer overflow and packet loss caused by the inconsistent bandwidths of the valid input ports and insufficient polling rate are eliminated, thereby improving the performance of processors.

### TECHNICAL FIELD

The present invention relates to the field of data communications, particularly to a method and device for scheduling data communication input ports.

### BACKGROUND

In the field of data communications, more and more input ports are included in communication devices along with the rapid development of data services. The bandwidths of these input ports are often different due to different demands. However, these input ports will be used by one processor simultaneously, resulting in overflow of a buffer area and data packet loss at the input port if the scheduling is improper and the input traffic of one port is larger than the polling processing capability of this port. Therefore, how to schedule the input ports and prevent the problem of overflow of the buffer area is crucial for the improvement of service quality and equipment performance.

Input ports are scheduled in the prior art by using an equal time slice polling or a is polling according to priority, and in the two ways, the buffer size for each input port is predefined and unchangeable.

In the equal time slice polling, the polling time slice of each input port is equally allocated according to a predefined polling period. If the bandwidths of these ports are identical, then both the corresponding buffer sizes of these ports and the input data traffic within each polling period are identical according to the buffer size allocated in direct proportion to the bandwidth, so that the overflow of the buffer area will not occur only by setting the processing capability of the polling time slice of each port larger than the input traffic of the port. But, in the actual operation, when the bandwidth of each input port is different, the buffer size for each port, allocated according to the direct proportion to the bandwidth, is different, and then the corresponding input data traffic is different too. Because the predefined port buffer cannot be changed, once the input data traffic of one port is larger than the processing capability of the polling time slice of this port, it is possible to cause the buffer overflow and data packet loss due to the insufficient polling rate and delayed processing.

For the polling according to the priority, the service is performed based on the priority, i.e., service first for high priority and then for low priority. But, like the equal time slice polling, when the bandwidths of the input ports having the same priority are different, the problem of the buffer overflow will arise too.

Therefore, how to overcome the defects of the above-mentioned methods and the devices thereof, and prevent the buffer overflow is the problem to be solved in the actual operation.

### SUMMARY

The technical problem to be solved by the present invention is to provide a method and device for scheduling data communication input ports to effectively solve the problems of buffer overflow and packet loss and to improve the performance of network processors.

To achieve the above-mentioned object, the present invention provides a device for scheduling data communication input ports, and the device comprises a resource preprocessing module, a port state monitoring module, a buffer resource allocating module, a time slice allocating module and a polling port module, wherein
the resource preprocessing module is used for setting priority of input ports and a proportion of time slices corresponding to the priority;
the port state monitoring module is used for monitoring a state of the input ports, acquiring a list of valid input ports and bandwidths, and classifying the valid input ports based on the list of the valid input ports according to the priority set by the resource preprocessing module;
the buffer resource allocating module is used for allocating a buffer size for each valid input port according to the priority of each valid input port predefined by the resource preprocessing module and the acquired bandwidths;
the time slice allocating module is used for allocating a service time slice corresponding to each priority and each valid input port; and
the polling port module is used for polling each valid input port from high priority to low priority according to the service time slice of each valid input port.

The present invention also provides a method for scheduling data communication input ports, the method comprises: setting priority of each valid input port and time proportion corresponding to each priority; and the method further comprises:
monitoring a state of each input port, acquiring a list of valid input ports, classifying the valid input ports based on the list of the valid input ports according to the priority, and acquiring the bandwidths of the valid input ports;
allocating a buffer size for each valid input port according to the priority of each valid input port and the acquired bandwidths;
allocating a service time slice corresponding to each priority and each valid input port; and
polling each valid input port from high priority to low priority according to the final service time slice of each valid input port.

In the allocation of buffer resource, the buffer sizes of the valid input ports may be allocated according to a direct proportion to the bandwidths of the valid input ports.

The allocation of the service time slice corresponding to each priority and each valid input port may comprise:
a: calculating the service time slice occupied by each valid input port in each priority according to a predefined priority time proportion; and
b: for the valid input ports having the same priority, further calculating the service time slice of each valid input port according to the bandwidth proportion of the valid input port to the total bandwidth in the priority.

The priority of each valid input port may be classified into high priority, medium priority and low priority.

The proportions of high priority, medium priority and low priority may be 50%, 40% and 10%, respectively.

The present invention is mainly to monitor the state of input ports, acquire the information about valid input ports, dynamically allocate the buffer size for the valid input ports according to the valid input ports, calculate a time slice according to the bandwidth and priority of each valid input port, and serve each valid input port according to the priority of the valid input ports and different time slices. With the above-mentioned method, the problems of buffer overflow and packet loss caused by the inconsistent bandwidths of the valid input ports and insufficient polling rate are eliminated, thereby improving the performance of processors.

### BRIEF DESCRIPTION OF THE DRAWINGS

FIG. 1 shows a structural diagram of a device for scheduling data communication input ports according to the present invention;

FIG. 2 shows an overall flowchart of a method for scheduling data communication input ports according to the present invention; and

FIG. 3 shows a flowchart of a method for scheduling data communication input ports according to an embodiment of the present invention.

### DETAILED DESCRIPTION

The present invention will be described in detail hereinafter with reference to the drawings.

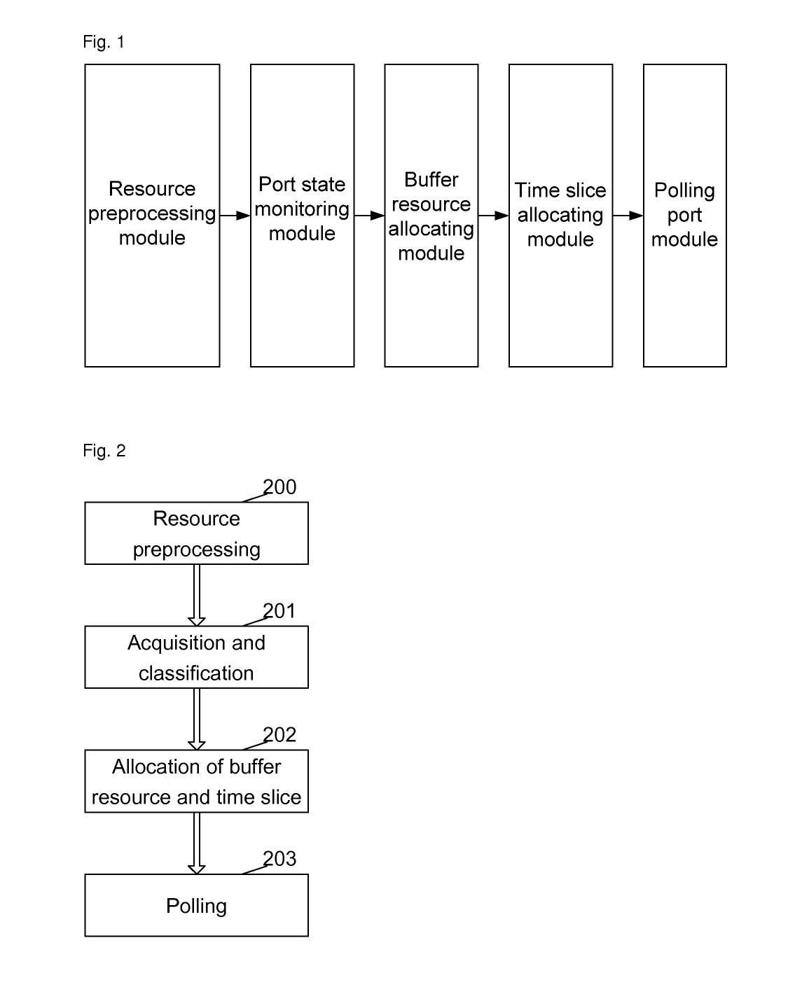

FIG. 1 shows a structural diagram of a device for scheduling data communication input ports according to the present invention. As shown in FIG. 1, the device comprises a resource preprocessing module, a port state monitoring module, a buffer resource allocating module, a time slice allocating module and a polling port module, wherein
the resource preprocessing module is used for setting priority of input ports and a is proportion of time slices corresponding to the priority;
the port state monitoring module is used for monitoring a state of the input ports, acquiring information about the valid input ports and bandwidths, and classifying the valid input ports based on a list of valid input ports according to the priority set by the resource preprocessing module;
the buffer resource allocating module is used for allocating a buffer size for each valid input port according to the priority of each valid input port predefined by the resource preprocessing module and the acquired bandwidths;
the time slice allocating module is used for allocating a service time slice corresponding to each priority and each valid input port; and
the polling port module is used for polling each valid input port from high priority to low priority according to the service time slice of each valid input port.

FIG. 2 shows an overall flowchart of a method for scheduling data communication input ports according to the present invention. With reference to FIG. 1, the method for scheduling data communication input ports according to the present invention mainly comprises:
step 200: resource preprocessing, wherein the resource preprocessing module sets priority of each input port and time proportion corresponding to each priority;
step 201: acquisition and classification, wherein the port state monitoring module monitors a state of each input port, acquires a list of valid input ports, classifies the valid input ports based on the list of the valid input ports according to the priority, and acquires the bandwidths of the valid input ports;
step 202: allocation of buffer resource and time slice, wherein the buffer resource allocating module allocates a buffer size for each valid input port according to the priority of each valid input port and the acquired bandwidths, and the time slice allocating module allocates a service time slice corresponding to each priority and each valid input port; and
step 203: polling, wherein the polling port module polls each valid input port from high priority to low priority according to the final service time slice of each valid input port.

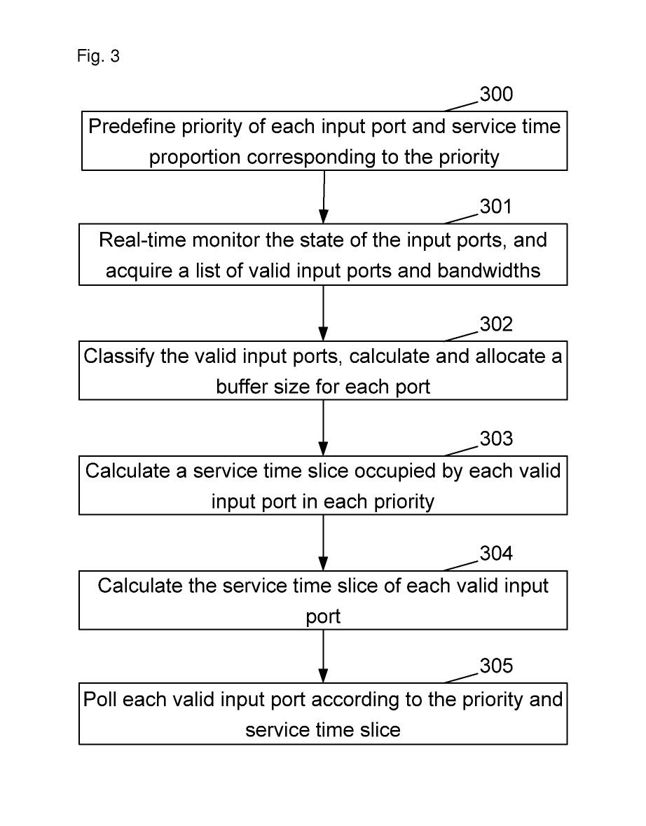

FIG. 3 shows an exemplified flowchart of a method for scheduling data communication input ports according to an embodiment of the present invention. As shown in FIG. 3, the embodiment specifically comprises the following steps:
step 300: the resource preprocessing module sets priority of each input port and service time proportion corresponding to the priority, wherein it is provided that there are 10 input ports in total, with the input ports 1 to 4, 5 to 8 and 9 to 10 of high priority, medium priority and low priority, and the service time proportions of 50%, 40% and 10%, respectively; and the classification of the priority and service time proportion of the priority in other embodiments can also be predefined according to the actual needs, not limited to the method of this embodiment;
step 301: the port state monitoring module monitors the state of the input ports and acquires a list of valid input ports, wherein, in this embodiment, the valid input port refers to the enabled input port, for example, if only input ports 1, 2, 5, 7 and 9 of above 10 input ports are enabled, the list of the valid input ports comprises #1, #2, #5, #7 and #9;
step 302: the buffer resource allocating module classifies the valid input ports according to the list of the valid input ports and the priority, acquires the bandwidths of the valid input ports, and allocates the buffer size for each valid input port based on the bandwidth of each valid input port according to a direct proportion to the bandwidths of the valid input ports;
in the valid input ports of step 301, this step comprises classification according to the priority, the list of the valid input ports having high priority includes input ports 1 and 2, the list of the valid input ports having medium priority includes input ports 5 and 7, and the list of the valid input port having low priority includes input port 9; it is provided that the bandwidths of the valid input ports acquired by searching the records about bandwidth information in the chips are 200M, 300M, 100M, 300M and 100M of the valid input ports #1, #2, #5, #7 and #9, respectively; if the total buffer size is 100 bytes, the buffer size for valid input port #1 is ( 2/10)*100=20 bytes and the buffer sizes of the valid input ports #2 and #7 are ( 3/10)*100=30 bytes according to the calculation directly proportional to the bandwidths of the valid input ports to allocate the buffer size; also, the buffer sizes of valid input ports #5 and #9 are 10 bytes; and for the invalid input ports, there is no need to allocate buffer to most effectively utilize the buffer resource;
step 303: the time slice allocating module calculates a service time slice occupied by each valid input port in each priority according to a predefined priority time proportion, wherein
it is provided that each polling period is 120 clocks, the service time slices of high priority, medium priority and low priority are 120*50%=60 clocks, 120*40%=48 clocks and 120*10%=12 clocks, respectively, according to the time slice proportion corresponding to the aforementioned priority;
step 304: for the valid input ports having the same priority, the time slice allocating module further calculates the service time slice of each valid input port according to the bandwidth proportion of the valid input port to the total bandwidth in the priority, wherein, according to the information acquired and calculated above, it is possible to calculate the time slice proportion of each port according to the proportion of the bandwidth of each valid input port to the bandwidth sum of the valid input ports of the same priority:
valid input port 1: [200M/(200M+300M)]=⅖;
valid input port 2: [300M/(200M+300M)]=⅗;
valid input port 5: [100/(100M+300M)]=¼;
valid input port 7: [300/(100M+300M)]=¾;
valid input port 9: 1/1=1;
the calculation method is not limited to herein, and other calculation methods can also be used as needed;
the time slice of each valid input port is allocated according to the proportion, and the service time slices of the valid input ports above are:
valid input port 1: (⅖)*60=24 clocks;
valid input port 2: (⅗)*60=36 clocks;
valid input port 5: (¼)*48=12 clocks;
valid input port 7: (¾)*48=36 clocks;
valid input port 9: 1*12=12 clocks;
it is assumed that each valid input port can process a byte per clock, each of the valid input ports #1, #2, #5, #7 and #9 can process 24, 36, 12, 36 and 12 bytes per period respectively, and larger than the input rates of the valid input ports, 20, 30, 10, 30 and 10 bytes, so the problem of buffer overflow of the valid input ports will not arise; and
step 305: the polling port module polls each valid input port from high priority to low priority according to the final service time slice of each valid input port.

From the embodiment, it can be seen that the present invention is mainly to monitor the state of input ports, acquire the information about the valid input ports, dynamically allocate the buffer size for the valid input ports according to the valid input ports, calculate a time slice according to the bandwidth and priority of each valid input port, and serve each valid input port according to the priority of the valid input ports and different time slices. With the above-mentioned method, the problems of buffer overflow and packet loss caused by the inconsistent bandwidths of the valid input ports and insufficient polling rate are eliminated, thereby improving the performance of processors.

The above is only the preferred embodiment of the present invention and not intended to limit the protection scope of the present invention, and any modifications, equivalent replacements, improvements and the like within the spirit and principle of the present invention shall fall within the protection scope of the present invention.

What is claimed is:

1. A device for scheduling data communication input ports, comprising a resource preprocessing module, a port state monitoring module, a buffer resource allocating module, a time slice allocating module and a polling port module, wherein
the resource preprocessing module is used for setting priority of input ports and a proportion of time slices corresponding to the priority;
the port state monitoring module is used for monitoring a state of the input ports, acquiring a list of valid input ports and bandwidths, and classifying the valid input ports based on the list of the valid input ports according to the priority set by the resource preprocessing module;
the buffer resource allocating module is used for allocating a buffer size for each valid input port according to the priority of each valid input port predefined by the resource preprocessing module and the acquired bandwidths;
the time slice allocating module is used for allocating a service time slice corresponding to each priority and each valid input port; and
the polling port module is used for polling each valid input port from high priority to low priority according to the service time slice of each valid input port.

2. A method for scheduling data communication input ports, comprising: setting priority of each valid input port and time proportion corresponding to each priority; further comprising:
monitoring a state of each input port, acquiring a list of valid input ports, classifying the valid input ports based on the list of the valid input ports according to the priority, and acquiring the bandwidths of the valid input ports;
allocating a buffer size for each valid input port according to the priority of each valid input port and the acquired bandwidths;
allocating a service time slice corresponding to each priority and each valid input port; and
polling each valid input port from high priority to low priority according to the final service time slice of each valid input port.

3. The method for scheduling data communication input ports according to claim 2, wherein in the allocation of buffer resource, the buffer sizes of the valid input ports are allocated according to a direct proportion to the bandwidths of the valid input ports.

4. The method for scheduling data communication input ports according to claim 2, wherein the allocation of the service time slice corresponding to each priority and each valid input port comprises:
a: calculating the service time slice occupied by each valid input port in each priority according to a predefined priority time proportion; and
b: for the valid input ports having the same priority, further calculating the service time slice of each valid input port according to the bandwidth proportion of the valid input port to the total bandwidth in the priority.

5. The method for scheduling data communication input ports according to claim 4, wherein the priority of each valid input port can be classified into high priority, medium priority and low priority.

6. The method for scheduling data communication input ports according to claim 5, wherein the proportions of high priority, medium priority and low priority are 50%, 40% and 10%, respectively.
